(19) United States
(12) Patent Application Publication
(10) Pub. No.: US 2004/0183366 A1
(43) Pub. Date: Sep. 23, 2004

(54) Vehicle brake system for reducing brake noise

(76) Inventors: Masahiko Kamiya, Anjo-city (JP); Hiroshi Kondo, Chiryu-city (JP); Shin Sasaki, Okazaki-city (JP); Daizo Oba, Kariya-city (JP)

Correspondence Address: POSZ & BETHARDS, PLC, 11250 ROGER BACON DRIVE, SUITE 10, RESTON, VA, 20190, US

(21) Appl. No.: 10/779,617

(22) Filed: Feb. 18, 2004

(30) Foreign Application Priority Data
Mar. 19, 2003 (JP) 2003-075816
Mar. 20, 2003 (JP) 2003-078394

(51) Int. Cl. B60T 8/40; B60T 13/18

(52) U.S. Cl. 303/11

(57) ABSTRACT

Master cylinder pressure generated in a master cylinder is transmitted to wheel cylinders through a linear valve that generates a differential pressure proportional to the amount of current supplied, and respective increase control valves. As a result, a braking force is generated. Brake fluid discharged from the wheel cylinders is, for example, reserved in a pressure regulating reservoir. The brake fluid sucked up from the pressure regulating reservoir by a pump is discharged to the downstream side of the linear valve, and then the fluid is again returned to the pressure regulating reservoir. When existence of brake noise is detected, dither control of the linear valve is executed. By setting a dither frequency to 500 Hz to 1 kHz which is lower than a resonance frequency of a caliper, pulsation for suppressing brake noise can be applied to the wheel cylinder pressure.

### CROSS REFERENCE TO RELATED APPLICATIONS

This application is based upon and claims the benefit of Japanese Patent Application No. 2003-075816 filed on Mar. 19, 2003 and No. 2003-078384 filed on Mar. 20, 2003, the content of which are incorporated herein by reference.

### FIELD OF THE INVENTION

The present invention relates to a vehicle brake system that reduces brake noise by using dither current.

### RELATED ART OF THE INVENTION

According to a related art as disclosed in, for example, Japanese Patent Laid-Open Publication No. 2000-337413, brake noise is suppressed by oscillating a hydraulic pressure in a brake line with a predetermined frequency by an oscillator that uses a piezoelectric device.

However, in order to oscillate the fluid, the related art described above requires the oscillator which is not originally included in a vehicle brake system, whereby the size of the system becomes large and the cost thereof becomes high.

Furthermore, according to another related art, for example, as disclosed in Japanese Patent Laid-Open Publication No. 2002-104169, by superimposing dither current on target current to be supplied to a brake driving actuator such as a motor, hysteresis of braking torque change during increase and decrease of the target current is suppressed, so that the target current is in proportion to the braking torque.

The aforementioned related art is intended to reduce power consumption of an actuator, and therefore, only a minimum required amount of dither current needs to be supplied and the dither current is stopped when a brake pedal depression is maintained and the braking force generated is thus fixed. Accordingly, such related art does not take into account a brake noise issue at all, and thus does not suppress the brake noise in a case it is generated during braking.

### SUMMARY OF THE INVENTION

In consideration of the aforementioned problems, it is an object of the present invention to suppress and prevent noise including brake noise with a simple construction.

It is another object of the present invention to reduce brake noise by controlling dither current that is superimposed on target current supplied to a brake driving actuator.

According to a first aspect of the present invention, when generation of brake noise or a possibility thereof is detected, the brake noise is suppressed by changing at least either one of amplitude and cycle of the dither current.

A correlation exists between an amplitude or a cycle (frequency) of braking force fluctuation and the brake noise generation. Accordingly, status are divided into a region where brake noise generates or is likely to generate and a region where brake noise does not generate or is not likely to generate according to the amplitude or cycle of braking force fluctuation. In the present invention, based on this consideration, when brake noise generation or a possibility thereof is detected, at least either one of the amplitude and cycle of dither current oscillation is changed. In accordance with this change, at least one of the amplitude and cycle (frequency) of the braking force fluctuation is changed. Thus, transition can be made from a state in which brake noise generates or is likely to generate to a state in which brake noise does not generate or is not likely to generate. Consequently, brake noise can be reduced and suppressed.

According to a second aspect of the present invention, if the brake noise generation is determined, that is, if it is determined that the brake noise is generated or is likely to generate when generation or non-generation of brake noise is detected, a pump is driven to apply a discharge pressure to the downstream side of a linear valve, and dither control of the linear valve is executed to change the amount of current supply by a predetermined dither frequency. Consequently, pulsation corresponding to the dither frequency can be applied to the hydraulic pressure supplied to a wheel cylinder. Accordingly, the brake noise can be suppressed or prevented. Moreover, the linear valve and the pump of the brake system of the present invention are provided to construct part of a vehicle stability control system or a traction control system of a normal vehicle control system. Therefore, the linear valve and the pump can be utilized to suppress brake noise, and thus, a special oscillator is not required.

According to a third aspect of the present invention, in a case in which normally-open increase control valves are provided between the linear valve and respective wheel cylinders for each vehicle wheel, valve switching is performed such that, for instance, a increase control valve of a vehicle wheel with which the brake noise is generated is turned off (an opened state), and a increase control valve of a vehicle wheel with which the brake noise is not generated is energized (a closed state). Accordingly, pulsation can be applied to the wheel cylinder pressure for only the vehicle wheel having brake noise.

It should be noted that by setting the dither frequency to a lower frequency than a resonance frequency of a brake caliper or a rotor of respective vehicle wheels, the brake noise which is self-excited vibration caused by sympathetic vibration of a caliper portion can be effectively suppressed or prevented.

### BRIEF DESCRIPTION OF THE DRAWINGS

Other objects, features and advantages of the present invention will be understood more fully from the following detailed description made with reference to the accompanying drawings. In the drawings:

FIG. 1 is a schematic diagram illustrating a construction of a vehicle brake system according to a first embodiment of the present invention;

FIG. 2 is a flowchart illustrating a procedure of processing executed by a brake control ECU 1 according to the first embodiment;

FIG. 3 is a flowchart illustrating a procedure of brake noise prevention control processing shown in FIG. 2;

FIG. 4 is a flowchart illustrating a procedure of the brake noise prevention control processing according to a second embodiment of the present invention;

FIG. 5 is a schematic diagram illustrating a construction of a vehicle brake system according to a third embodiment of the present invention;

FIG. 6A is a diagram illustrating dither current waveforms;

FIG. 6B is a diagram illustrating fluctuating waveforms of piston thrust of a brake driving actuator based on dither current;

FIG. 7 is a graph illustrating a relation of a cycle τ and an amplitude Δi of the dither current and a brake noise generation region and a brake noise non-generation region;

FIG. 8 is a chart showing variations in dither current setting conditions for suppressing and avoiding brake noise; and

FIG. 9 is a flowchart illustrating a procedure of processing for suppressing the brake noise according to the third embodiment.

### DETAILED DESCRIPTION OF THE PREFERRED EMBODIMENTS

The present invention will be described further with reference to various embodiments in the drawings.

(First Embodiment)

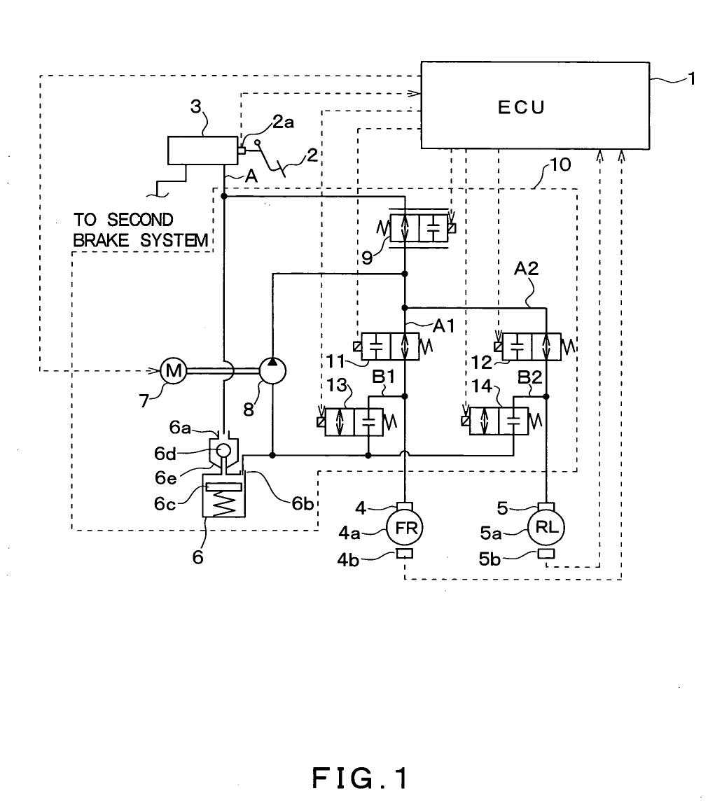

A vehicle brake system according to a first embodiment of the present invention will be described with reference to the attached drawings. FIG. 1 is a diagram illustrating a schematic construction according to the present embodiment.

This vehicle brake system can perform well-known control including anti-lock brake system (ABS) control, a traction control (TCS), and a vehicle stability control (VSC) for controlling vehicle behavior during turning. As shown in FIG. 1, this brake system is provided with a brake control ECU (hereinafter simply referred to as “ECU”) 1, by which various types of controls are executed.

Furthermore, the vehicle brake system of the first embodiment executes control to reduce or prevent brake noise by the ECU 1 when brake noise is generated or is likely to generate during braking. The basic construction of the brake system to be controlled by the ECU 1 will be explained below. It should be noted that FIG. 1 shows a state in which no power is supplied to respective solenoids by the ECU 1.

The vehicle brake system is controlled based on the amount of depression of a brake pedal 2. The brake pedal 2 is connected with a master cylinder 3 via a push rod or the like. When the brake pedal 2 is depressed, the push rod pressurizes a master piston so that brake fluid pressure corresponding to the pedal depression force is generated within the master cylinder 3.

Master cylinder pressure generated in the master cylinder 3 is transmitted to wheel cylinders 4, 5 provided for respective vehicle wheels 4a, 5a via a first brake system. In addition to the first brake system in which the master cylinder pressure of a primary chamber side of the master cylinder 3 is transmitted, the vehicle brake system is actually provided with a second brake system in which the master cylinder pressure of a secondary chamber side is transmitted. However, since the construction of the second brake system is the same as that of the first brake system, descriptions will be given of the first brake system only.

In the first embodiment, the first and second brake systems are denoted as an X line. The first brake system is connected with a front right wheel (FR) and a rear left wheel (RL), and the second brake system is connected with a front left wheel (FL) and a rear right wheel (RR). The following descriptions will be given of the first brake system as an example, however, the same descriptions apply to the second brake system.

The first brake system is provided with a brake conduit (main brake conduit) A that connects the master cylinder 3 and the wheel cylinders 4, 5. The brake conduit A is provided with a pressure regulating reservoir 6 and a hydraulic pump 8 which is a pump unit driven by a motor 7. The brake fluid on a side of the master cylinder 3 is pumped into the hydraulic pump 8 via the pressure regulating reservoir 6, and discharged to the wheel cylinders 4, 5.

The pressure regulating reservoir 6 is provided with a first reservoir hole 6a, a second reservoir hole 6b, a reservoir piston 6c, a valve body 6d that operates in association with the reservoir piston 6c, and a valve seat 6e on which the valve body 6d seats. The first reservoir hole 6a is connected to a side of the master cylinder 3 and the second reservoir hole 6b is connected to a side of the hydraulic pump 8. According to such construction, when a predetermined amount of the pressure regulating reservoir 6 is supplied with the brake fluid from the side of the master cylinder 3 through the first reservoir hole 6a, the valve body 6d comes into contact with the valve seat 6e to regulate the pressure such that high-pressure brake fluid is not supplied to the hydraulic pump 8 through the second reservoir hole 6b. On the other hand, the hydraulic pump 8 is constructed of a rotary pump or the like, for example, a trochoid pump, so that the brake fluid can be pumped in or discharged according to the number of gear revolutions.

Furthermore, the brake conduit A is branched into two brake conduits (first and second brake conduits) A1, A2 at the downstream of a discharge port of the hydraulic pump 8. The brake conduit A1 is connected with the wheel cylinder 4 that corresponds to the front right wheel, and the brake conduit A2 is connected with the wheel cylinder 5 that corresponds to the rear left wheel. The brake conduits A1, A2 are provided with the increase control valves 11, 12, respectively, each of which is constructed of a two position valve that is controlled in an opened state or a closed state. Opened state and closed state of the brake conduits A1, A2 can be controlled by the increase control valves 11, 12, respectively.

Moreover, brake conduits B1, B2 connect a point between respective increase control valves 11, 12 and respective wheel cylinders 4, 5 in the brake conduits A1, A2, and a point between the pressure regulating reservoir 6 and the hydraulic pump 8 in the brake conduit A. The brake conduits B1, B2 are provided with a decrease control valves 13, 14, respectively, each of which is composed of the two position valve. Opened state and closed state of each brake conduit B1, B2 can be controlled by the decrease control valves 13, 14, respectively.

The increase control valves 11, 12 and the decrease control valves 13, 14 serving as a known brake actuator 10 are controlled by the ECU 1, whereby pressure of respective wheel cylinders 4, 5 is increased, retained, or reduced. According to this operation, various control including ABS, TCS, and VSC is executed.

In addition, a linear valve 9 is provided between the master cylinder 3 and the respective increase control valves 11, 12 in the brake conduit A. The discharge port of the hydraulic pump 8 is connected between the linear valve 9 and respective increase control valves 11, 12. The linear valve 9 is controlled so as to produce differential pressure proportional to the amount of current supplied by the ECU 1. That is, by executing the dither control based on the dither frequency, the linear valve 9 can control the differential pressure between the brake fluid pressure on a side of the discharge port of the hydraulic pump 8 and the master cylinder pressure based on the fluctuating amount of current supplied.

Normally during operation of the VSC and the like, to increase or decrease predetermined wheel cylinder pressure when the brake pedal 2 is not being depressed, the hydraulic pressure pump 8 is operated to generate discharge pressure, and in this state, the amount of current supplied to the linear valve 9 is increased or decreased. According to the amount of the current supplied to the linear valve 9, the differential pressure before and after the brake fluid passes through the linear valve 9 increases or decreases, whereby the wheel cylinder pressure is controlled. At the time of increase or decrease of the amount of the current supplied to the linear valve 9, the dither current is superimposed on the current supplied to reduce hysteresis of the differential pressure generated. For reducing of the hysteresis, the dither frequency is set to, for instance, around 1 kHz to several kHz.

The first brake system as constructed above is provided with various sensors constituting various detection units for detecting a state of each component element. Among these sensors, a stop switch sensor 2a provided in the brake pedal 2, and vehicle wheel speed sensors 4b, 5b for detecting wheel speed that are provided to vicinity of the rotors of respective vehicle wheels 4a, 5a are shown in FIG. 1. Detection signals of the respective sensors 2a, 4b, 5b are input to the ECU 1.

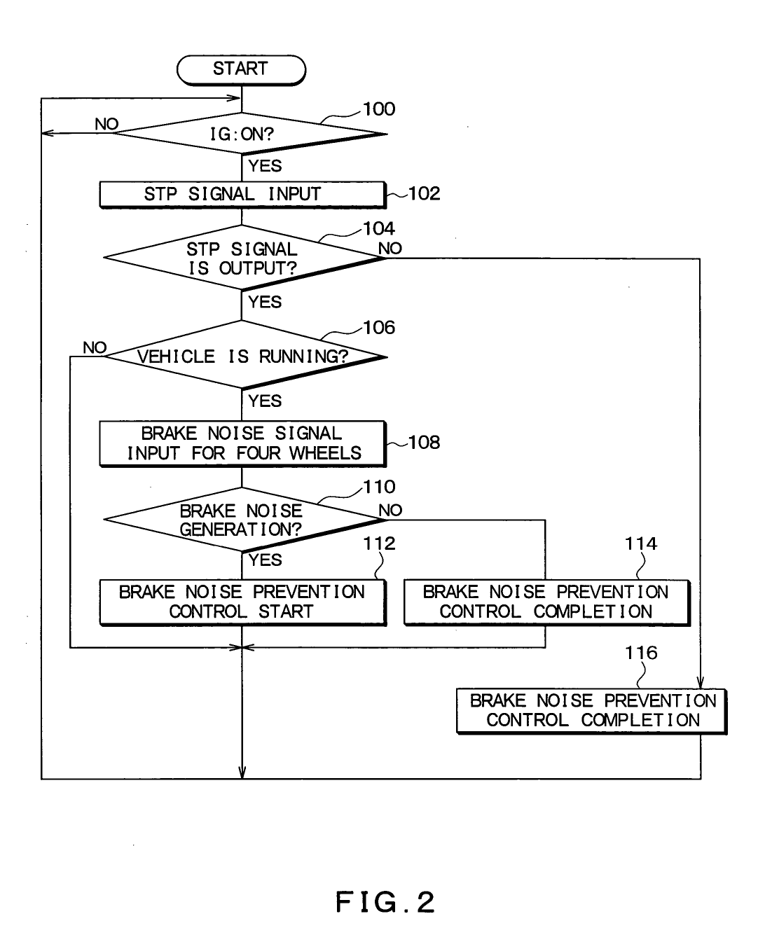

Next, the brake noise prevention control processing executed by the ECU 1 in the vehicle brake control system as constructed above will be described in detail. FIG. 2 shows a flowchart of a procedure of processing executed by the ECU 1, on which the following descriptions will be based.

First, at 100 of the procedure, it is determined that an ignition switch of the vehicle is turned on and then, at 102, a stop switch signal of the stop switch sensor 2a has already been output. If it is determined that the stop switch signal is output at 104, the procedure proceeds to processing at 106. On the other hand, if the stop switch signal does not exist, the procedure proceeds to processing at 116 to complete the brake noise prevention control.

At 106, whether the vehicle is running or not is determined based on detection signals of the vehicle wheel speed sensors 4b, 5b. If it is determined that the vehicle is not in a running state, the procedure returns to processing at 100, and if it is determined that the vehicle is in a running state, the procedure proceeds to processing at 108.

A brake noise detection signal of each vehicle wheel is input at 108 because the fluctuation component of the vehicle wheel speed caused by the brake noise is included in the output signals of respective vehicle wheel speed sensors 4b, 5b, namely, the vehicle wheel speed signals. Fluctuation in the vehicle wheel speed caused by the brake noise appears, for example, as a several-kHz signal, and therefore, such several-kHz signal can be extracted by FFT or the like based on the vehicle wheel speed signals in the ECU 1.

Alternatively, at 108, a vibration sensor is provided for a caliper of each wheel by which self-excited vibration of the caliper caused by the brake noise is detected. Such a detected signal may be employed as a brake noise detection signal.

In the subsequent processing at 110, if there is a brake noise detection signal of at least one vehicle wheel, brake noise generation is determined and the procedure proceeds to processing at 112. To the contrary, if there is no brake noise detection signal, the procedure proceeds to processing at 114 to complete the brake noise prevention control.

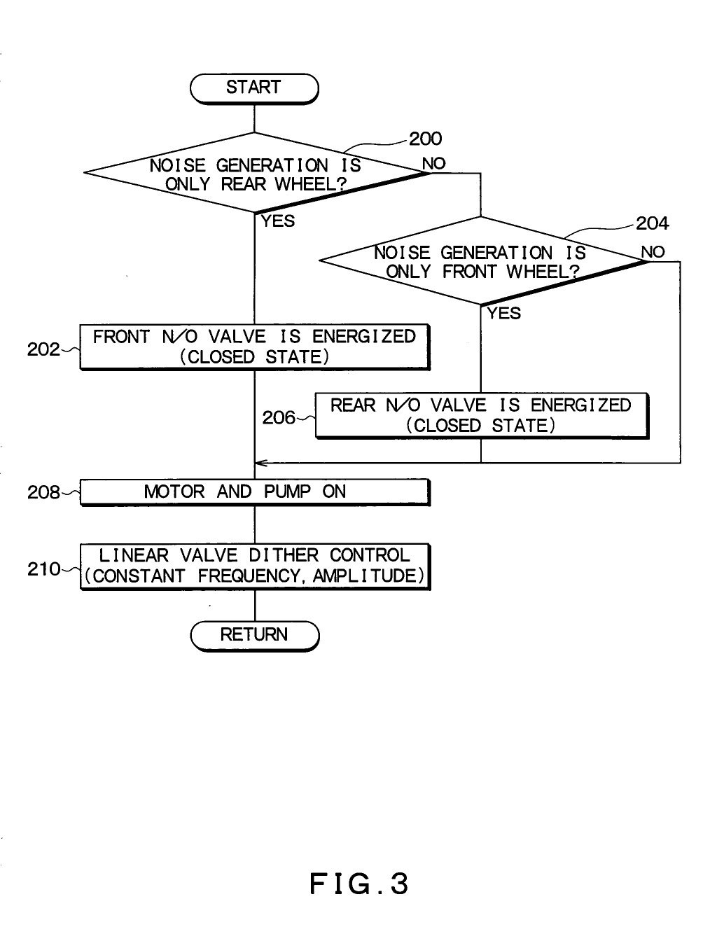

Hereafter, the processing of the brake noise prevention control at 112 will be explained in detail with reference to the flowchart in FIG. 3. It should be noted that, in this flowchart, the control for the first brake system and that for the second brake system are executed in parallel. The following descriptions are based on the processing procedure for the first brake system.

At 200, brake noise generation in the rear wheel of the first brake system (or the real left wheel 5) only is determined based on the brake noise detection signal input at 108. If noise generation is not determined, the procedure proceeds to processing at 204, and if noise generation is determined, the procedure proceeds to processing at 202.

At 202, a normally-open valve of the front wheel of the first brake system (or the front right wheel 4), that is, the increase control valve 11 is energized. Accordingly, the increase control valve 11 is controlled in the closed state, and the wheel cylinder pressure of the front right wheel 4 is retained. Meanwhile, the increase control valve 12 which is a normally-open valve of the rear wheel of the first brake system (or the rear left wheel 5) remains unenergized, in other words, an opened state is established. Consequently, pulsation can be generated in the rear wheel cylinder only.

On the other hand, at 204, brake noise generation in the front wheel of the first brake system (or the front right wheel 4) only is determined based on the input brake noise detection signal. If noise generation is not determined, neither of the normally-open valves, or the increase control valves 11, 12, are not energized and keeping the brake conduit in an opened state, and the procedure proceeds to processing at 208. If the brake noise generation is determined, at 206, the increase control valve 12 which is a normally-open valve of the rear wheel of the first brake system (or the rear left wheel 5) is energized. Accordingly, the increase control valve 12 is closed, and the wheel cylinder pressure of the rear left wheel 5 is retained. Meanwhile, the increase control valve 11 which is a normally-open valve of the front wheel of the first brake system (or the front right wheel 4) remains unenergized, in other words, the opened state is established. Consequently, pulsation can be generated in the front wheel cylinder only.

In the subsequent processing at 208, a motor 7 is rotated by a drive signal from the ECU 1. Accordingly, the hydraulic pump 8 sucks up the brake fluid from the master cylinder 3 through the pressure regulating reservoir 6 in accordance with the rotation speed of the motor 7, so as to discharge the brake fluid to a portion between the linear valve 9 and the increase control valves 11, 12.

Then, the dither control of the linear valve 9 is executed at 210. That is, the ECU 1 supplies a solenoid of the linear valve 9 with current onto which the dither current of a predetermined dither frequency and a predetermined amplitude is superimposed.

By setting the dither frequency in the brake noise prevention control to a lower frequency than a resonance frequency of the brake caliper or the rotor, brake noise which is self-excited vibration of the caliper can be suppressed or prevented. It should be noted that, since a lower limit of the brake noise frequency is around 1 kHz, the dither frequency is preferably set to 1 kHz or lower. Moreover, it is preferable to set the dither frequency to approximately 500 Hz in terms of suppressing or preventing brake noise.

In addition, the current amplitude in the dither control may suffice if it is enough for generating micro-vibration to suppress sympathetic vibration of the caliper. However, the current amplitude is preferably set to a larger value as the brake noise vibration increases. The magnitude of the brake noise vibration may be determined, for example, by the amplitude of fluctuation of the vehicle wheel speed signals obtained as described above.

Moreover, whatever repeated cycle waveform of the current takes, including sine wave, rectangular wave, triangular wave, and the like, if such the repeated cycle waveform corresponds to the aforementioned dither frequency (approximately 500 Hz to 1 kHz), brake noise can be effectively suppressed or prevented by applying pulsation of such repeated cycles to each wheel cylinder pressure.

As described above, according to the first embodiment, by using the linear valve 9 and the hydraulic pump 8 provided in a normal brake system or the like that is capable of executing the VSC, and simply by superimposing the dither current having a lower frequency than the resonance frequency of the caliper onto the current supplied to the linear valve 9, brake noise can be suppressed or prevented without requiring a special oscillator.

Furthermore, according to the first embodiment, opened state and closed state of the increase control valves 11, 12 provided between the linear valve 9 and the wheel cylinders 4, 5 are switched as appropriate, whereby pulsation can be generated in the wheel cylinder pressure of only a wheel with which the brake noise is generated.

(Second Embodiment)

Hereafter, a vehicle brake system according to a second embodiment of the present invention will be described. It should be noted that the construction of the second embodiment is identical to that of the first embodiment except the content of the brake noise prevention control processing at 112. Therefore, descriptions of the construction (FIG. 1) and the processing (FIG. 2) that are same as in the first embodiment will be omitted.

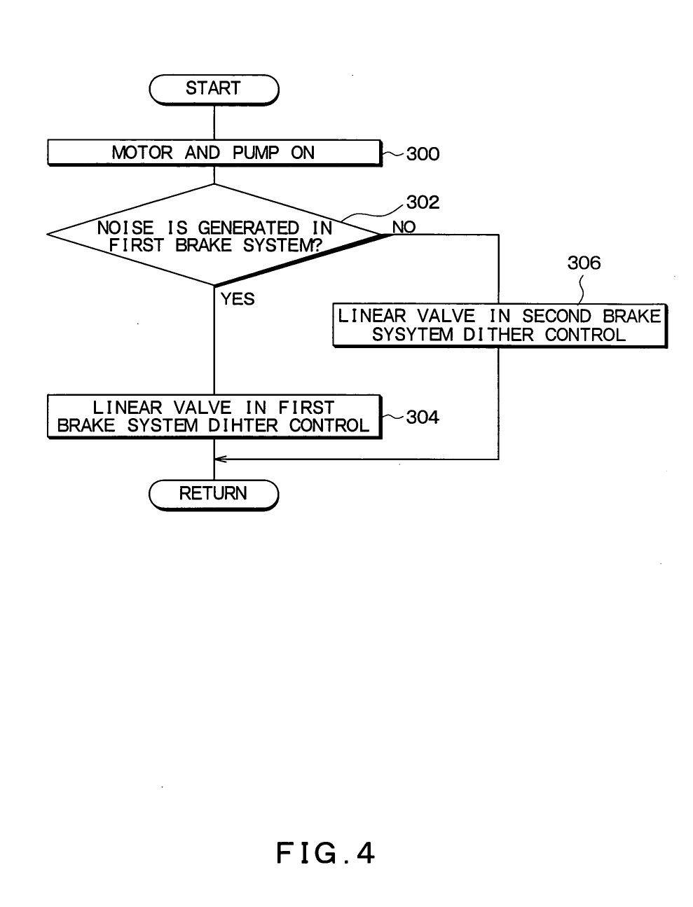

FIG. 4 is a flowchart illustrating a processing procedure of the brake noise prevention control according to the second embodiment. At 300, the motor 7 is first rotated, and brake fluid is discharged to the downstream of the linear valve 9 by the pump 8.

Then, at 302, based on a brake noise detection signal imported at 108, it is determined whether the brake noise has been generated in the first brake system, that is, in at least either one of the front right wheel 4 and the rear left wheel 5. If noise generation is determined, the procedure proceeds to processing at 304, and if no noise generation is determined, the procedure proceeds to processing at step 306.

At 304, the dither control of the linear valve 9 of the first brake system is executed. The dither frequency and amplitude at this time are set in similar way as in the first embodiment.

According to the second embodiment, unlike the first embodiment, none of the increase control valves 11, 12 of the first brake system and the increase control valves of the second brake system are energized and thus all kept in an opened state. Consequently, pulsation can be applied uniformly to both wheel cylinders 4, 5 of the first brake system.

At 306, the dither control of the linear valve of the second brake system is executed. The dither frequency and amplitude at this time are set in similar way as in the first embodiment. Accordingly, pulsation can be applied uniformly to both wheel cylinders provided for the front left wheel and the rear right wheel of the second brake system.

As described above, in the second embodiment, when brake fluid pressure is applied to each wheel cylinder of the first and second brake systems, pulsation for the brake noise prevention control can be applied uniformly to each of these brake systems, thus realizing a simple construction of the system as well as power consumption reduction.

(Third Embodiment)

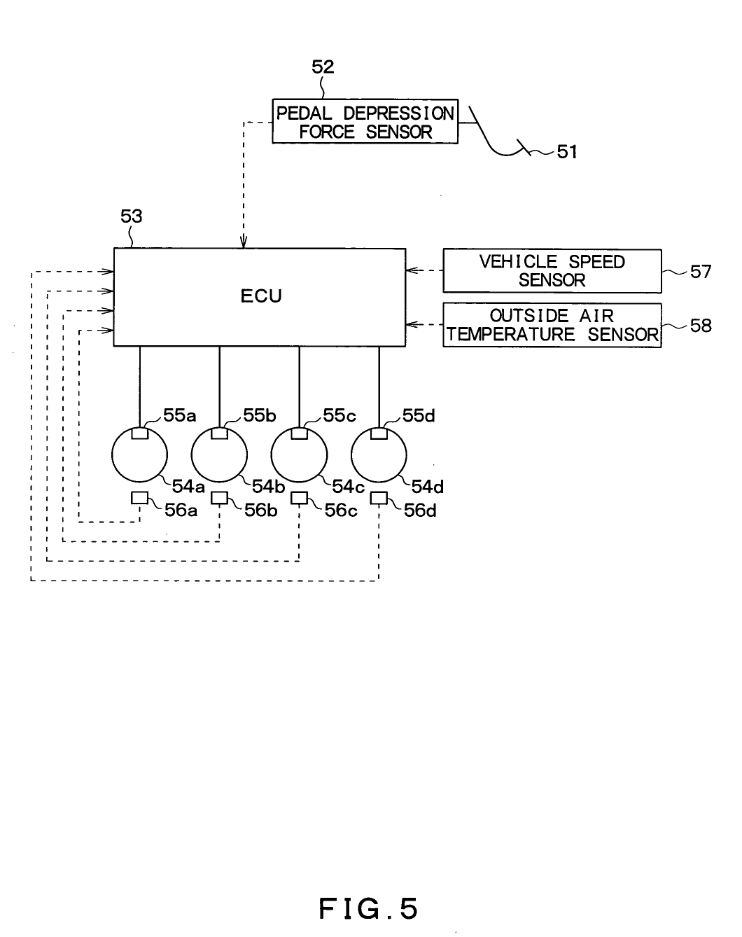

FIG. 5 shows a schematic construction of a vehicle brake system according to a third embodiment of the present invention. The third embodiment is one of the embodiments of the present invention applied to an electric brake that generates the braking force electrically. Hereafter, descriptions will be given of the construction of the brake system according to the third embodiment with reference to FIG. 5.

As shown in FIG. 5, the brake system is provided with a brake pedal 51 operated by a driver, a pedal depression force sensor 52 which detects a pedal depression force representing a depression state of the brake pedal 51, an ECU 53 to which a detection signal is input from the pedal depression force sensor 52, and brake driving actuators (braking force generating portions) 55a to 55d that are provided for vehicle wheels 54a to 54d, respectively, and generate the braking force to respective vehicle wheels 54a to 54d by being driven by the ECU 53.

Based on a detection signal of the pedal depression force sensor 52, the ECU 53 determines target current corresponding to the pedal depression force, that is, current to be supplied to the brake driving actuators 55a to 55d, and controls the brake driving actuators 55a to 55d by supplying the target current.

The brake driving actuators 55a to 55d are constructed, for example, of a motor, and a disc brake or drum brake that is driven by this motor, or the like, such that the braking force can be adjusted by regulating the amount of current supplied to the motor. Then, when target current onto which dither current is superimposed is supplied from the ECU 53, the brake driving actuators 55a to 55d generate braking force that is proportional to the target current.

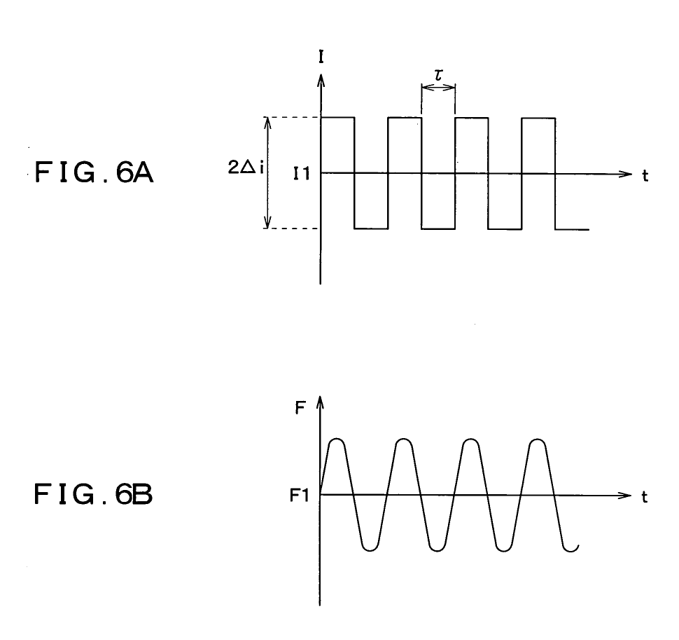

That is, as shown in FIG. 6A, dither current that varies, for instance, by an amplitude value 2Δi in repeated cycles τ is superimposed onto target current I1. Corresponding to the target current onto which the dither current is superimposed, as shown in FIG. 6B, a piston thrust F that is generated by the brake driving actuators 55a to 55d and pushes a brake pad will include a thrust F1 a force level of which is proportional to the target current I1, having fluctuation the size and cycle of which correspond to the amplitude 2Δi and the cycle τ of the dither current.

Such fluctuation can prevent hysteresis from occurring in the piston thrust of the brake driving actuators 55a to 55d, or in braking force change. In addition, time-averaged fluctuation in the braking force corresponding to the dither current becomes zero. Consequently, by the target current onto which the dither current is superimposed, the brake driving actuators 55a to 55d can generate a braking force proportional to the target current. It should be noted that the amplitude and cycle of dither current during normal braking are set to a value necessary for suppressing hysteresis and minimizing fluctuation.

According to this construction, when the brake pedal 51 is depressed by a driver, pedal depression force is detected by the pedal depression force sensor 52, and calculation in the ECU 53 is executed based on the detected pedal depression force. Then, output current corresponding to the operation result is supplied to the brake driving actuators 55a to 55d, thereby executing brake control corresponding to the amount of depression of the brake pedal 51.

Furthermore, the ECU 53 is connected with vehicle wheel speed sensors 56a to 56d for detecting a wheel speed of each wheel, a vehicle speed sensor 57 for detecting a vehicle speed, and an outside air temperature sensor 58 that is included in an air conditioning system (not shown) and detects a temperature outside the vehicle. Based on signals from the respective sensors, the ECU 53 determines if brake noise has been generated, or if there is a possibility of brake noise generation.

That is, since brake noise is generated as noise having a relatively high frequency due to vibration of a movable member constituting the brake system being increased through self excitation, the ECU 53 determines that the brake noise is generated when vibration of several hundreds of Hz to several kHz that corresponds to the vibration frequency of the brake noise is included in each signal output from respective vehicle wheel speed sensors 56a to 56d.

Furthermore, brake noise is generally likely to occur at a low vehicle speed, a low braking force, and in a cold state. Thus, the ECU 53 sets the following determination conditions.

(1) A vehicle speed value determined based on an output signal from the vehicle speed sensor 57 is 30 km/h or lower.

(2) A value of the generated braking force calculated based on target current supplied to respective brake driving actuators 55a to 55d is 0.3 G or lower (G is acceleration of gravity).

(3) A value of the generated braking force remains constant at least one second.

(4) After an ignition switch is turned on, a running distance which is an integral of the vehicle speed is 5 km or less.

(5) An outside air temperature is 15° C. or lower.

When an appropriate combination of the aforementioned conditions (1) to (5), for example, a combination of (1), (2) and (4), or that of (1), (3), and (5), is established, the determination conditions for brake noise generation possibility is established, and thus the ECU 53 determines the possibility of brake noise generation exists.

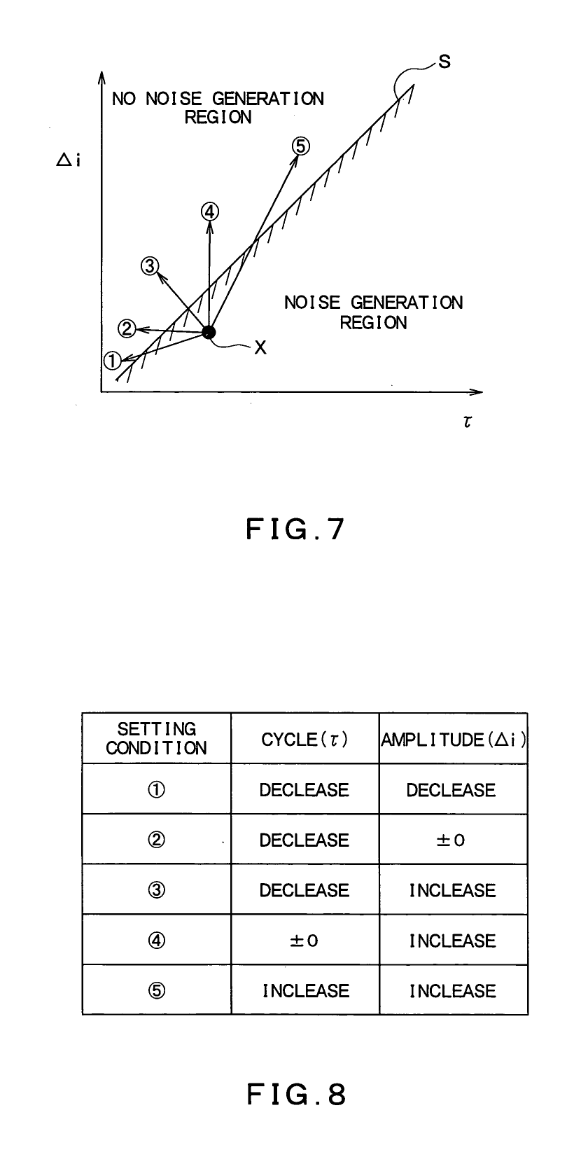

Hereafter, a relation between the brake noise generation and the cycle τ and amplitude Δi of dither current will be described. FIG. 7 indicates the cycle τ on a horizontal axis and the amplitude Δi on a vertical axis, and represents a result of an experiment conducted to show conditions under which brake noise generates or is likely to generate, and conditions under which brake noise does not generate or is not likely to generate. The result of the experiment reveals that the entire region is divided into two regions of a brake noise generation region and a brake noise non-generation region by a straight line S as shown in FIG. 7.

To suppress brake noise in a case it is generated, the cycle τ and/or amplitude Δi of the dither current can simply be changed so as to shift from the brake noise generation region shown at the lower right side in FIG. 7 to the brake noise non-generation region shown at the upper right side in FIG. 7. In other words, when a time point of brake noise generation is expressed by a point X (•), brake noise can be suppressed by changing setting conditions such as conditions [1] to [5] as shown in FIG. 8.

A setting condition [1] allows transition to the brake noise non-generation region by reducing the cycle τ and also reducing the amplitude Δi. A setting condition [2] allows transition to the brake noise non-generation region by reducing the cycle τ while keeping the amplitude Δi constant. A setting condition [3] allows transition to the brake noise non-generation region by reducing the cycle τ and at the same time increasing the amplitude Δi. A setting condition [4] allows transition to the brake noise non-generation region by increasing the amplitude Δi while keeping the cycle τ constant. Furthermore, a setting condition [5] allows transition to the brake noise non-generation region by increasing the cycle τ and also increasing the amplitude Δi.

As described above, the cycle τ and amplitude Δi of the dither current can be changed variously to reduce or suppress brake noise or to prevent generation of brake noise.

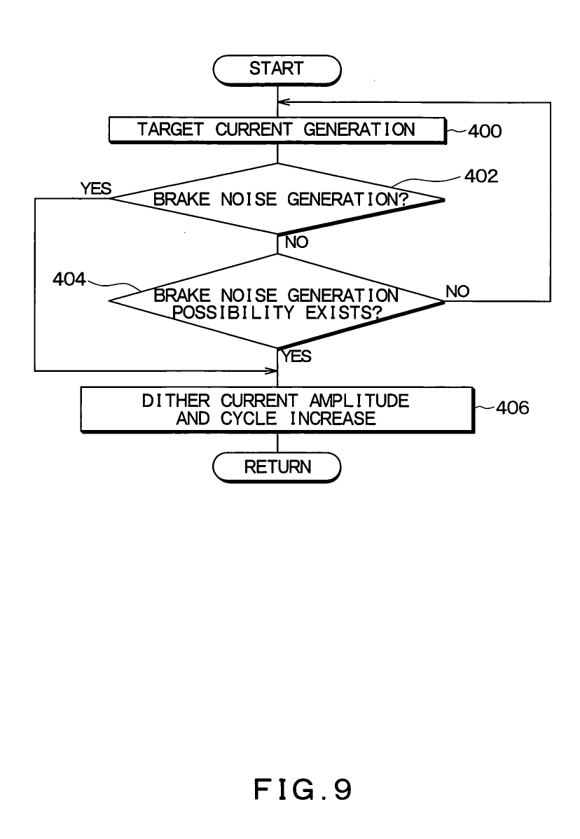

Next, a method for changing setting of dither current supplied to respective brake driving actuators 55a to 55d according to the present embodiment will be described with reference to a flowchart shown in FIG. 9.

First, at 400, based on a pedal depression force detected by the pedal depression force sensor 52, target current onto which minimum required dither current for suppressing hysteresis is superimposed is generated as a normal brake operation condition. Accordingly, braking force proportional to the target current is generated by the brake driving actuators.

Then, whether brake noise has been generated is determined at 402 based on the vibration frequency as described above. If it is determined that the brake noise has been generated, the procedure proceeds to processing at 406. On the other hand, if it is determined that the brake noise has not been generated, the procedure proceeds to processing at 404.

At 404, determination is made, based on the determination conditions for brake noise generation possibility mentioned above, as to whether a possibility of brake noise generation exists although the brake noise is not generated at present. If the determination result is “NO”, it is determined that no brake noise generation occurs and also that there is no possibility of brake noise generation, and the procedure returns to the processing at 400. To the contrary, if the determination result is “YES”, it is determined that no brake noise generation currently exists, but that there is a possibility of brake noise generation, and the procedure proceeds to processing at 406.

At 406, the cycle τ and the amplitude Δi of the dither current are both changed to increase based on the aforementioned setting condition [5]. Consequently, as shown in FIG. 7, transition can be made from a state in which brake noise has been generated or a possibility of brake noise generation exists to a state in which brake noise does not generate or is not likely to generate. It should be noted that the setting change of the dither current may be conducted only for a wheel with which the brake noise has been generated, or uniformly on all of the four wheels.

As described above, according to the third embodiment, the dither current is superimposed on the target current to be supplied to the brake driving actuators 55a to 55d, and when the brake noise generation or a possibility thereof is detected while the braking force is being generated, the cycle and amplitude of the dither current are changed so as to make transition from the brake noise generation region to the brake noise non-generation region. As a result, brake noise can be reduced, suppressed, or avoided.

Moreover, according to the present embodiment, the cycle and/or amplitude of the dither current is simply changed to reduce, suppress, or avoid brake noise. Therefore, an average braking force of a wheel (single wheel or four wheels) setting condition of which is changed does not change, and a required braking force based on each target current is secured. Consequently, there is an advantage that the braking force of respective wheels is balanced, preventing occurrence of an unstable vehicle behavior. Furthermore, since a control device of a normal electric brake system can be used without any modification added and a setting condition of the dither current may simply be changed in such control device, the brake noise prevention system can be realized in a simple and low-cost construction.

In the aforementioned embodiment, the brake noise generation is determined by judging whether the vibration frequency corresponding to the brake noise is included in the output signals of the vehicle wheel speed sensors 56a to 56d. However, the determination method is not limited to this, and for example, a vibration sensor may be provided to a caliper of the brake system to determine the brake noise generation based on vibration directly caused by brake noise that is directly detected by the vibration sensor.

Furthermore, the generated braking force used to determine whether a possibility of brake noise generation exists may be estimated from longitudinal acceleration of a vehicle body detected by a longitudinal acceleration sensor. Alternatively, a load, or a braking force, applied to a brake pad may be directly measured by a load sensor.

Other Embodiments

In the first and second embodiments above, brake noise generation is detected based on as to whether a fluctuating frequency of vehicle wheel speed caused by the brake noise is included in the output signals of respective vehicle wheel speed sensors 4b, 5b, and so on, namely, a vehicle wheel speed. However, the brake noise generation itself may not necessarily be detected.

As explained in the third embodiment, it is known that the brake noise is likely to generate at a low vehicle speed, a low outside air temperature, and a low braking force. Therefore, based on output from various sensors (not shown) including a vehicle speed signal, outside temperature, and brake fluid pressure, a possibility of brake noise generation is determined by judging whether values of these output are within a preset brake noise generation region. If it is determined that the possibility of brake noise generation exists, the dither control of the linear valve 9 is executed as in each of the embodiments above, thereby preventing brake noise generation.

Adversely, in the third embodiment, the brake noise determination method may be based on a fluctuating frequency of vehicle wheel speed as described in the first and second embodiments, instead of based on the conditions under which brake noise is likely to generate.

While the above description is of the preferred embodiments of the present invention, it should be appreciated that the invention may be modified, altered, or varied without deviating from the scope and fair meaning of the following claims.

What is claimed is:

1. A vehicle brake system for generating braking force in each vehicle wheel according to operation of a brake pedal, comprising:
a braking force regulating portion that is controlled by dither current and generates the braking force;
a brake noise detecting portion for detecting at least one of brake noise generation and a possibility thereof in each vehicle wheel; and
a control portion for controlling the dither current, wherein
when either the brake noise generation or the possibility thereof is detected by the brake noise detecting portion, the control portion changes at least one of an amplitude and a cycle of the dither current to suppress brake noise.

2. The vehicle brake system according to claim 1, further comprising;
a master cylinder for generating a master cylinder pressure;
a wheel cylinder provided for each vehicle wheel for receiving the master cylinder pressure that is introduced from the master cylinder through a brake conduit, thereby applying wheel cylinder pressure to each wheel cylinder to generate braking force in the vehicle wheel; and
a pump for sucking up brake fluid from the master cylinder and discharges the brake fluid between the linear valve and the wheel cylinder is further provided; wherein
the braking force regulating portion is a linear valve that is provided upstream of the wheel cylinder and generates differential pressure proportional to an amount of current supplied; and
the control portion changes at least one of the amplitude and the cycle of the dither current to be supplied to the linear valve, thereby generating hydraulic pulsation in accordance with a dither cycle of the dither current.

3. The vehicle brake system according to claim 2, further comprising:
a normally-open increase control valve provided between the linear valve and the each wheel cylinder, wherein
the control portion executes switching control of the each increase control valve and generates the hydraulic pulsation in only a vehicle wheel that has been determined to have brake noise generation.

4. The vehicle brake system according to claim 2, wherein the dither frequency is lower than a resonance frequency of a brake caliper or a rotor of each vehicle wheel.

5. The vehicle brake system according to claim 1, wherein the braking force regulating portion is a brake driving actuator provided for each vehicle wheel, and the control portion superimposes the dither current on a target current which is determined according to the amount of depression of the brake pedal, and supplies the brake driving actuators of each vehicle wheel with the target current, as output current, onto which the dither current is superimposed, so as to drive the brake driving actuator, thereby generating braking force in each wheel.

6. The vehicle brake system according to claim 5, wherein the cycle of the dither current for the brake driving actuator of the vehicle wheel is reduced when the brake noise generation or the possibility thereof exists.

7. The vehicle brake system according to claim 5, wherein the amplitude of the dither current for the brake driving actuator of the vehicle wheel is increased when the brake noise generation or the possibility thereof exists.

8. The vehicle brake system according to claim 5, wherein the cycle and the amplitude of the dither current for the brake driving actuator of the vehicle wheel are both reduced when the brake noise generation or the possibility thereof exists.

9. The vehicle brake system according to claim 5, wherein the cycle and the amplitude of the dither current for the brake driving actuator of the vehicle wheel are both increased when the brake noise generation or the possibility thereof exists.
